(19) United States
(12) Patent Application Publication
(10) Pub. No.: US 2022/0418049 A1
(43) Pub. Date: Dec. 29, 2022

(54) A HEATING SYSTEM AND METHOD OF MANUFACTURING A HEATING SYSTEM

(71) Applicant: Grundfos Holding A/S, Bjerringbro (DK)

(72) Inventors: Flemming Buus Bendixen, Hobro (DK); Alexandro Sorea, Aalborg Ø (DK); Peter Valler, Aalborg SØ (DK); Henrik Rasmussen, Rødkærsbro (DK); Allan Ivo Søegaard, Hobro (DK)

(21) Appl. No.: 17/781,648

(22) PCT Filed: Dec. 3, 2020
(86) PCT No.: PCT/EP2020/084445

§ 371 Date: Jun. 1, 2022

(30) Foreign Application Priority Data
Dec. 4, 2019 (EP) 19213513.5
Dec. 4, 2019 (EP) 19213705.7

(51) Int. Cl. H05B 3/82; H05B 3/12; F24H 1/10; F24H 3/00; B22F 3/20; B22F 3/10; B22F 7/06

(52) U.S. Cl. CPC H05B 3/82; H05B 3/12; F24H 1/103; F24H 3/002; B22F 3/20; B22F 3/10; B22F 7/062; H05B 2203/017; H05B 2203/037; H05B 2203/016; H05B 2203/003; F24H 7/002

(57) ABSTRACT

The invention relates to a heating system (200) for heating of a fluid. The heating system comprises a supply connection (201) in fluid communication with a supply of fluid to be heated. It further comprises a structured body (108) arranged for heating of the fluid during use of the heating system. The structured body comprises a macroscopic structure (21) of electrically conductive material, the macroscopic structure comprising at least one channel (22) through which the fluid can flow. The heating system further comprises at least two conductors (103,114) configured to electrically connect the structured body to at least one electrical power supply. The at least two conductors are electrically connected to the structured body at a first end (204) and at a second end (205), respectively, of a conductive path within the structured body. The structured body is configured to direct an electrical current to run along the conductive path from the first end to the second end thereof. The electrical power supply is configured to heat at least part of said structured body to a temperature of below 400° C. by passing an electrical current through said structured body during use of the heating system.

### FIELD OF THE INVENTION

The present invention relates to a heating system for heating of a fluid, and in particular to a heating system wherein the fluid is heated by flowing through a structured body being heated by electric power.

### BACKGROUND OF THE INVENTION

Fluid heating systems for all types of applications are well known in the art. With the wide variety of conditions, many different types of heaters have been developed that use different sources of energy and different heater components to heat fluids for different ranges of temperatures for different applications. In the present art, fluid heat exchangers are limited in the maximum operating temperature. A classical configuration of a heat exchanger is the tube and shell type, where one fluid flows on the tube side and heat exchanges with another fluid on the shell side to thereby heat the first fluid and cool the second fluid, or vice versa.

More specifically, fluid heating systems, including steam, hydronic (water), and thermal fluid boilers, constitute a broad class of devices for producing a heated fluid for use in domestic, industrial, and commercial applications. Because of the desire for improved energy efficiency, compactness, reliability, and cost reduction, there remains a need for improved fluid heating systems, as well as improved methods of manufacture thereof. It is also desirable to develop a heating system, specifically a fluid heater, which allows for heating fluids very efficiently to high temperatures. It is also desirable to develop a fluid heating system which is compact and simple to operate.

Hence, an improved heating system for heating fluid would be advantageous.

### OBJECT OF THE INVENTION

It is an object of the present invention to provide a heating system which is more efficient than corresponding prior art systems.

It is another object of the present invention to provide a heating system with which the heating capacity can be quickly adapted to a varying demand.

It is an object of at least some embodiments of the present invention to provide a heating system which is more compact than corresponding prior art systems.

It is another object of the present invention to provide an alternative to the prior art.

In particular, it may be seen as an object of the present invention to provide a heating system that solves the above mentioned problems of the prior art.

### SUMMARY OF THE INVENTION

Thus, the above described object and several other objects are intended to be obtained in a first aspect of the invention by providing a heating system for heating of a fluid, said heating system comprising:
a supply connection in fluid communication with a supply of fluid to be heated,
a structured body arranged for heating of said fluid during use of the heating system, said structured body comprising a macroscopic structure of electrically conductive material, the macroscopic structure comprising at least one channel through which the fluid can flow,
at least one inlet port through which the fluid to be heated can flow from the supply connection and into the at least one channel,
at least one outlet port through which heated fluid can flow out of the at least one channel, and
at least two conductors configured to electrically connect the structured body to at least one electrical power supply,
   wherein the at least two conductors are electrically connected to the structured body at a first end and at a second end, respectively, of an electrically conductive path within the structured body,
   wherein the structured body is configured to direct an electrical current to run along the conductive path from the first end to the second end thereof, and
   wherein said electrical power supply is configured to be used to heat at least part of said structured body to a temperature of below 400° C. by passing an electrical current through said structured body during use of the heating system.

The supply of fluid can be a part of the system or an external supply. It may e.g. be a pipe through which a fluid to be heated runs continuously, or it may be a tank containing fluid which tank is at least partly emptied by supplying the fluid to the heating system before more fluid is filled into the tank. The supply of fluid may come from more than one supply, such as from two or more tanks and/or via two or more pipelines. In that case it may be mixed before being led into the heating system. The fluid may be either gas or liquid and some non-limiting examples will be given below.

The at least two conductors may be connected to one electrical power supply, or they may be connected to more than one electrical power supply. There may e.g. be more pairs of conductors, and each pair may be connected to one electric power supply.

One of the conductors may be a grounded part of the heating system or of an electrically conducting element to which the system is connected. The structured body may be assembled from more than one macroscopic body as will be shown in relation to the figures.

The feature of “the electrical power supply being configured to be used to heat at least part of said structured body to a temperature of below 400° C. by passing an electrical current through said structured body during use of the system” is both related to the power supply and the structured body as well as to the whole design. It typically includes the use of a control unit which receives signals from sensors arranged at different positions of the system so that information on the actual values of selected process parameters are constantly measured and used to ensure a desired temperature based on a demand. If an actual temperature is about to exceed a desired temperature, it may e.g. be necessary to lower the supplied power.

An advantageous feature of a resistance heating process, such as one used in relation to the present invention, is that the energy is supplied inside the macroscopic body itself, instead of being supplied from an external heat source via heat conduction, convection and radiation. Hereby the heat can be created very quickly directly where it is to be transferred to the fluid being heated so that a more efficient process is obtained. It may typically be possible to reduce the distance between the heat providing element, i.e. the structured body, and the fluid to be heated to be μm instead of mm. Such a system is therefore very efficient.

A further advantage of a heating system according to the present invention is that it is easier to control precisely, e.g. to match a varying demand, than corresponding known systems. This is due to a fast reaction to e.g. a lowering or increase in the applied power. Another advantage is that the temperature is more homogeneous over the whole of the heat providing element than what would be the case for a system based on an external heating source arranged next to the heat providing element. This will be illustrated in FIG. 11 below.

The electrically conductive material is advantageously a coherent or consistently intra-connected material in order to achieve electrical conductivity throughout the electrically conductive material, and thereby achieve thermal conductivity throughout the structured body. By the coherent or consistently intra-connected material it is possible to ensure uniform distribution of current within the electrically conductive material and thus uniform distribution of heat within the structured body. The term “coherent” is meant to be synonymous to cohesive and thus refer to a material that is consistently intra-connected or consistently coupled. The effect of the structured body being a coherent or consistently intra-connected material is that a control over the connectivity within the material of the structured body and thus the conductivity of the electrically conductive material is obtained. It is to be noted that even if further modifications of the electrically conductive material are carried out, such as provision of slits within parts of the electrically conductive material or the implementation of insulating material within the electrically conductive material, the electrically conductive material is still denoted a coherent or consistently intra-connected material.

The term “electrically conductive” is meant to denote materials with an electrical resistivity in the range from: 10⁻⁵ to 10⁻⁸ Ω·m at 20° C. Thus, materials that are electrically conductive are e.g. metals like copper, silver, aluminium, chromium, iron, nickel, or alloys of metals. Moreover, the term “electrically insulating” is meant to denote materials with an electrical resistivity above 10 Ω·m at 20° C., e.g. in the range from 10⁹ to 10²⁵ Ω·m at 20° C. The resistivity of the electrically conductive material is suitably between 10⁻⁵ Ω·m and 10⁻⁷ Ω·m. A material with a resistivity within this range provides for an efficient heating of the structured body when energized with a power source. Graphite has a resistivity of about 10⁻⁵ Ω·m at 20° C., kanthal has a resistivity of about 10⁻⁶ Ω·m at 20° C., whilst stainless steel has a resistivity of about 10⁻⁷ Ω·m at 20° C. The electrically conductive material may for example be made of FeCrAlloy having a resistivity of ca. 1.5·10⁻⁶ Ω·m at 20° C. Material that has a resistivity from 10⁻⁵ Ω·m to 10 Ω·m can in some special cases also be used for the material in the structured body.

For some of the materials used for the development of the present invention, the electric resistivity is almost constant over the relevant temperature ranges during use of the heating system. This makes the heating process stable and controllable, and it will also decrease the risk of hotspots. An example is of materials with almost constant electric resistivity is FeCrAl alloys which are used in a wide range of resistance and high-temperature applications. They have a resistivity of about 1.4μΩ·m and a temperature coefficient of +49 ppm/K (i.e. +49×10⁻⁶ K⁻¹).

It should be noted, that the system of the invention may include any appropriate number of power supplies and any appropriate number of conductors connecting the power supply/supplies and the electrically conductive material of the structured body.

A heating system according to the present invention has a very compact design compared to known systems used for similar applications. It is able to efficiently transfer huge amounts of heat to the fluid within a limited space and with only a small pressure drop across the system.

In some embodiments of the invention, the macroscopic structure is a sintered or oxidized powder metallurgical structure. It may e.g. be made from a metal comprising one or more of the following chemical elements: iron, chromium, aluminium, cobalt, nickel, manganese, molybdenum, vanadium, and silicon. In general, the metal for use in these embodiments may be any metal that is available as powder. A non-exhaustive list of possible metals include: 316L, FeCrAl, Inconel 625, Hastalloy X, 17-4PH, 430L, and 304L.

The macroscopic structure may furthermore comprise ceramic material, such as one or more of the following: Alumina, Zirconia, Boron Nitride, Cordierite, and Silicon Nitride.

In embodiments wherein the macroscopic structure is a sintered powder metallurgical structure, it may have been manufactured by a method comprising the following steps:
preparing a paste by mixing at least:
   a powder comprising metal,
   a binder in an amount of 2 to 8 weight % of the paste,
   liquid, such as water, in an amount of 5 to 25 weight % of the paste,
transferring the paste to an extruder,
extruding the paste into a green body by using an extrusion pressure of more than 50 bar,
drying the green body, and
sintering or oxidizing the dried green body to bond the powder together and thereby form the macroscopic structure.

By “paste” is meant a thick, soft, sticky substance made by mixing a liquid with a powder. In other words, pastes typically consist of a suspension of granular material in a background fluid. In the context of the present invention, the viscosity of the paste should be so that it allows for the necessary handling of the paste during the transfer from the device used for the mixing and to the extruder. It should also allow for the subsequent process steps; i.e. it should be low enough to allow for the extrusion and high enough to ensure that the extruded green body keeps the desired geometry. The viscosity of a given paste can be determined by equipment and methods designed therefore, such as by use of a capillary rheometer which is typically used to measure shear viscosity and other rheological properties. However, since the viscosity is correlated to the hardness of the material, it will also be possible to use this parameter in the determination of whether a given paste is suitable for the manufacturing method or not. A possible related measure to use is the Shore Hardness which can be determined in accordance with ISO 868/ASTM D2240. Another option is to use a special tool designed for clays; this has been used during the development of the present invention. This tool is similar to a Shore tester but has been adapted for the characterization of clays; such an instrument can also be referred to as a durometer for clays. The operating principle is based on the force exerted by the sample material on the penetration of the calibrated spring of the instrument, when a pin of the tool is pressed into the material being tested until the pin reaches a support. In this way, a steady force at a steady stroke is always applied to the instrument. It has a scale from 0 to 20 to use as a relative hardness reference parameter, and gram scale of applied force. With this tool, a penetration point is pressed into the paste when it comes out of the kneader. Then the maximum value indicated at the moment when the penetration point is inside the paste is measured. The maximum point is used instead of waiting for it to stabilize because it will eventually show a much lower value, maybe getting close to 0 as the penetration point would be forced through the paste. With this method, it has been found that values higher than 12 Shore are necessary to obtain a satisfactory result, at least for the geometries tested.

A binder or a binding agent is any material or substance that holds or draws other materials together to form a cohesive unit mechanically, chemically, by adhesion or cohesion. The binder is preferably organic, such as cellulose ethers, agarose or polyoxymethylene. Examples of binders are: methylcellulose, 25 poly(ethylene oxide), poly(vinyl alcohol), sodium carboxymethylcellulose (cellulose gum), alginates, ethyl cellulose and pitch.

The binder may be in an amount of 2 to 7 weight % of the paste, such as in an amount of 2 to 6 weight % of the paste, or such as in an amount of 3 to 5 weight % of the paste. The liquid, such as water, may be in an amount of 5 to 15 weight % of the paste, such as 5 to 10 weight % of the paste, or it may be in an amount of 10 to 20 weight % of the paste, such as in an amount of 12 to 18 weight % of the paste.

In presently preferred embodiments, the liquid is water, including demineralized water. However, it may also be possible to use other types of liquid which are particularly suitable for mixing with a given combination of powder and binder. Such liquids could e.g. be Ethanol or Isopropyl alcohol.

The paste may also comprise other components, such as viscosity modifiers, dispersants, flocculants, and lubricants.

By “extrusion pressure” is preferably meant the pressure in the pressure head during the extrusion. The extrusion pressure is measured as close as possible to the die. It is the pressure which is generated by the compression of the paste against the die by the forward movement of the piston in a piston extruder or the rotation of the one or more screws of a screw extruder.

The extrusion pressure may be between 50 and 500 bar, such as between 50 and 200 bar, preferably between 60 and 160 bar, most preferably between 60 and 150 bar. If the pressure is too low for a given paste and geometry, the extrusion cannot be performed as the pressure is too low for forcing the paste through the die. If the pressure is too high, the extrusion speed increases which may cause defects in the green body.

The drying step is typically performed in a controlled atmosphere involving controlling the temperature and the humidity in which the green body is placed. It may further include passing a flow of gas, such as air, along the green body, and the speed of the flow of the gas may then also be controlled.

In any of the embodiments as described above, the macroscopic structure may have a varying electric resistivity in a direction extending from the inlet port to the outlet port. The macroscopic structure may have a varying electric resistivity transverse to a direction extending from the inlet port to the outlet port. The macroscopic structure may have an electric resistivity that varies in 3D. By using a macroscopic structure with a varying electric resistivity, the electrical properties and thereby the heating capability of the structured body can be adapted to a given application of the heating system. It may e.g. be possible to subject the fluid to a predetermined temperature profile as it flows through the at least one channel of the macroscopic body.

The varying electric resistivity along the macroscopic structure may mean that other parameters typically vary as well. These parameters could e.g. be mechanical properties, such as stiffness and fracture strength.

In some embodiments of the invention where the macroscopic body has a varying electric resistivity, the varying electric resistivity has been obtained by a method of manufacturing comprising the following steps:
preparing a plurality of pastes comprising:
   at least a first paste having a first composition, and
   at least a second paste having a second composition,
transferring the plurality of pastes into a supply chamber of a processing equipment,
shaping a green body from the plurality of pastes by forcing the pastes from the supply chamber through a die of the processing equipment, and
sintering or oxidizing the green body to obtain the macroscopic structure having the varying electric resistivity along a longitudinal direction of the macroscopic structure, the longitudinal direction corresponding to the direction of movement of the pastes through the die, and the varying electric resistivity resulting from the first composition being different from the second composition.

In embodiments being made with a method as just described, the heating system may be described by the following features:
the first paste comprises metal powder with a first alloy composition, ceramic powder, and a first binder,
the second paste comprises metal powder with a second alloy composition and a second binder, and
   wherein the first alloy composition and the second alloy composition both consist of at least one chemical element, and wherein the chemical elements are chosen so that, for each of the chemical elements being present in an amount higher than 0.5 weight % in each of the alloy compositions, that chemical element is comprised both in the first and second alloy composition, and
for the chemical elements being present in the first alloy composition in amounts of up to 5.0 weight %, the amount of that chemical element differs by at most 1 percentage point between the first and second alloy compositions, and
for the chemical elements being present in the first alloy composition in amounts of more than 5.0 weight %, the amount of that chemical element differs by at most 3 percentage point between the first and second alloy compositions.

Hereby it can be obtained that after sintering or oxidizing, the metal powder form a coherent structure without any abrupt interfaces between materials originating from two neighbouring pastes. Thereby weaknesses, such as due to defects, that could otherwise lead to fracture can be avoided. Further advantages of having the first and second compositions as just described are that the metal structure has substantially the same properties throughout; such properties are e.g. the mechanical properties, corrosion resistance and creep resistance. Furthermore, the metal part of the macroscopic structure will have substantially the same heat expansion and shrinkage both during the sintering and during use of the macroscopic structure whereby the risk of thermal stresses can be minimized.

The wording “alloy” is used throughout the description and claims, since most often the first and second alloy compositions each comprises at least two chemical elements forming an alloy. For embodiments including using at least one paste with only one chemical element, this is also included in the wording “alloy” even though it could also simply be referred to as “metal composition” instead of “alloy composition”. This means that the different compositions of the two or more different pastes may include one or more of the pastes having only one chemical element, such as iron or copper.

The first binder and the second binder may have similar or the same solvability in order to ensure the same flow properties of the extruded material during the extrusion.

In embodiments wherein the macroscopic structure has a varying electric resistivity, this may have been obtained by including ceramic powder during manufacturing. The different resistivities may then be obtained by varying one or more of the following parameters:
the volume ratio between the metal powder and the ceramic powder,
the size of the ceramic particles,
the shape of the ceramic particles, and
the type of the ceramic material.

By “size” is meant any measure typically used to describe this parameter in relation to powder. It typically includes taking into account both the average size and the size distribution of the particles.

Which of the design parameters to use may depend on the requirements on other properties of the macroscopic structure, such as mechanical stiffness or impact strength. The determination of the actual choice for a given macroscopic structure can be made e.g. by experimentation and/or by computer simulations.

In any of the embodiments as described above, the macroscopic structure may comprise a plurality of longitudinally extending channels, such as having a honeycomb structure. Examples of such geometries will be given in relation to the figures. Such a plurality of channels are typically arranged in a regular pattern, but with the present invention it is also possible to extrude macroscopic structures wherein the channels are arranged in an irregular pattern. The channels may be separated by walls having a wall thickness of between 0.25 and 2 mm, such as between 0.25 and 1 mm, such as between 0.25 and 0.5 mm.

The macroscopic structure in any of embodiments of a heating system as described above may be made from a non-corrosive material or may be provided with a coating, such as a coating of non-corrosive material, at least on surfaces being in contact with the fluid during use of the heating system. By non-corrosive is meant a material which is resistant to corrosion. It can also be defined by the non-corrosive material being a material that has an allowed maximum rate of weight loss over time. For example, a loss of less than 1% of the weight of the structured body over 100 days might be considered as acceptable. Thus, a ceramic coating may e.g. be applied to maintain a chemically inert environment to thereby limit or even avoid surface reactions on metal surfaces of the macroscopic structure.

The connections between the at least two conductors and the structured body may be established by sintering. They may alternatively be established by welding, soldering, brazing, or mechanical connections.

The structured body may be built-up of two or more macroscopic structures which have been mutually joined by an electrically conducting connection.

In such an embodiment and wherein the macroscopic structures are sintered or oxidized powder metallurgical structures, the macroscopic structures may have been joined by sintering.

In some embodiments of the invention, the first end and the second end of the electrically conductive path to which the at least two conductors are electrically connected may be located at an end of the structured body comprising the inlet port (202).

In such embodiments, the conductors may be arranged at opposite sides of the heating system and both may extend in the same direction parallel to a longitudinal direction of the structured body; furthermore, the structured body may comprise electrically insulating regions so that the conductive path runs in a meandering manner between the first end and the second end of the conductive path.

In some embodiments of the invention, the structured body comprises two or more macroscopic structures which have been mutually joined by an electrically conducting connection. In such embodiments, the macroscopic structures may have been joined by sintering.

Such a method of joining may include a step of enabling the joining by:
at least partly dissolving a first joining surface of a first macroscopic structure and/or a second joining surface of a second macroscopic structure by applying a solvent, and
bringing the first joining surface in contact with the second joining surface and maintaining this contact for a time period allowing for at least some evaporation of the solvent; and then
   sintering the macroscopic structures together.

Alternatively, a method of joining two macroscopic structures may include a step of enabling the joining by:
arranging a mixture comprising dissolved binder and metal powder a first joining surface of a first macroscopic structure and a second joining surface of a second macroscopic structure, and
arranging the first and second joining surfaces as close together as possible while sandwiching the mixture there between, and maintaining the first and second joining surfaces in contact with the mixture; and then
   sintering the macroscopic structures together.

The mixture may e.g. be arranged in a pre-determined pattern, such as in a pattern selected from straight lines, curved lines, circles, dots, and combinations thereof. The mixture may be arranged by use of 3D-printing.

Alternatively, a method of joining two macroscopic structures may include a step of enabling the joining by:
with at least one of the first macroscopic structure and the second macroscopic structure being brought in a wet condition by use of a solvent, bringing a first joining surface of the first macroscopic structure in contact with a second joining surface of the second macroscopic structure and maintaining this contact for a time period allowing for at least some evaporation of the solvent; and
   sintering the macroscopic structures together.

After sintering together the macroscopic structures as just described, former interfaces between the first and second joining surfaces and, when present, the mixture can typically not be identified or are close to inconspicuous by use of Scanning Electron Microscopy analysis.

By making the structured body from two or more macroscopic structures, it may be easier to tailor the electric properties to match a given application e.g. by using macroscopic structures having different electric resistances. The design of the structured body as well as the whole system may e.g. be performed by a combination of computer simulations and experimentation.

Another advantage of building the structured body from two or more macroscopic structures is that it may be easier to make different sizes of structured bodies by using such a modular design. It will e.g. be possible to make different designs by use of one specific manufacturing equipment, such as an extruder. Furthermore, it may be easier to make large structured bodies that would be difficult or impossible to manufacture as one unit. This could e.g. be the case if the final size exceeds the capacity of the available manufacturing equipment, or if an attempt to make the structured body as one unit was likely to make it too difficult to ensure the desired geometrical, mechanical and electrical properties throughout the structured body.

In some embodiments of the invention, the first end and the second end of the electrically conductive path to which the at least two conductors are electrically connected are located at an end of the structured body comprising the inlet port. This end is sometimes referred to as “the cold end” because it is where the fluid flows in for being heated by the system. Thus, by arranging both of the conductors at this end, they can be connected to the structured body with a lower risk of thermally induced damage of the joint happening during use of the system. This will be particularly relevant, when the connections are made by temperature sensitive methods, such as e.g. soldering. Another advantage is that by keeping the temperature of the sealings surrounding the electrical conductors relatively low, it is easier to maintain the thermal and electrical properties of the sealings and thereby to maintain the needed fluid tightness and thermal and electrical insulating properties over time.

In the description of the invention, the main focus has been put on the heating resulting in an increase in the temperature of the fluid. However, in combination with increasing the temperature of the fluid, a phase shift into gas could also take place. Such an effect of the supply of energy to the fluid provided by a heating system according to the invention is intended to be another relevant use of the system even though it is not specifically mentioned in the remainder of the description.

In some embodiments of the invention, the conductors may be arranged at opposite sides of the heating system and both extend in the same direction parallel to a longitudinal direction of the structured body, and the structured body may comprise electrically insulating regions so that the conductive path runs in a meandering manner between the first end and second ends of the conductive path. The electrically insulating regions may e.g. be formed by ceramic material, polymer material, or air gaps. Such a structured body may e.g. be established by cutting slots in one macroscopic body, or it may be established by assembly of a plurality of macroscopic bodies. Such an assembly could e.g. be obtained by sintering as described above. Advantages of a design of a heating system as just described will be explained in further details in relation to the figures.

A heating system according to any of the embodiments as described above may further comprise an outer housing enclosing at least a part of the structured body. In some embodiments, it can be a housing forming a fluid tight enclosure extending from the inlet port to the outlet port. By fluid tight it is meant that the system is protected against fluid leakage under the normal operating conditions of the heating system. In some embodiments, it can also be a first sealing zone sealing the inlet port against leakage and a second sealing zone sealing the outlet port against leakage. First and second sealing zones may comprise gaskets, e.g. gaskets made of O-rings or flat gaskets. Fluid leakage can also be understood as rate of pressure loss of the heating system over time. For example, a loss of less than 1% of the non-operating pressure of the system over 100 days.

Thus, it is an advantage of such embodiments of the invention that the heating system can be made to remain fluid tight even in the case of fluids under huge pressure, such as water under high pressure at high temperature.

In a heating system according to any of the embodiments as described above, the structured body may comprise an outer circumferential wall which provides a fluid tight barrier towards the exterior, the fluid tight barrier extending from the inlet port to the outlet port. This may e.g. be obtained by the structured body as manufactured, e.g. as sintered, or it may be obtained by applying a fluid tight coating thereto.

The structured body may be provided with a surrounding outer electrically insulating covering and/or thermally insulating covering. It may e.g. be in the form of a mantle made from a polymer material.

In a heating system of the present invention, the heating is obtained via the electrical current being applied to the macroscopic structure of electrically conductive material. However, since many of the types of fluids that can be heated by the heating system are to some extent electrically conductive, a part of the design process will include ensuring that the heating system is protected against short-circuiting caused by a part of the electrical current running via the fluid. This can e.g. be done by building in barriers of insulating material, if necessary for a given application.

In a second aspect, the present invention relates to a method of heating a fluid to below 400 degrees C. by use of a heating system according to any of the embodiments as described above. A non-exhaustive list of examples of such methods include use of the described heating system for heating of portable water, disinfection of water, evaporation of liquids i.e. making steam, and heating of steam.

In some embodiments according to the second aspect of the invention, the fluid is a liquid, such as water, which is heated to a temperature of below 100° C., such as between 50 and 100° C., such as between 70 and 100° C. Such embodiments may e.g. be used for the cleaning of water, such as drinking water or waste water. Which temperature to use depends on the actual application and the chemical content of the water. The temperature should be chosen in combination with the duration of the heating treatment to ensure that the desired effect is obtained.

Such an effect could e.g. be that all undesired bacteria or virus present in the untreated water is killed. The desired effect of heating a liquid could also be the heating itself, e.g. in case the liquid needs to have a certain temperature before use in another process.

In some other embodiments according to the second aspect of the invention, the fluid is a gas which is heated to a temperature of between 200 and 400° C., such as between 300 and 400° C. This could e.g. be for the use as a solar power plant booster and/or pre-heater in a concentrating solar power (CSP) system.

In some embodiments according to the second aspect of the invention, the method further comprises a step of transferring the heated fluid from the at least one outlet port to a storage for storing the heated fluid as an energy reservoir. In this way, the energy reservoir can e.g. be used to store energy from wind power as thermal energy.

For some applications, it may be advantageous to supply the fluid in a pressurized condition, e.g. to cause some turbulence and thereby obtain a more efficient transfer of the heat to the fluid.

The first and second aspect of the present invention may be combined. These and other aspects of the invention will be apparent from and elucidated with reference to the embodiments described hereinafter.

### BRIEF DESCRIPTION OF THE FIGURES

The heating system according to the invention will now be described in more detail with regard to the accompanying figures. The figures show one way of implementing the present invention and is not to be construed as being limiting to other possible embodiments falling within the scope of the attached claim set.

FIG. 1 shows schematically a heating system according to the present invention.

FIG. 2 shows schematically examples of possible designs of the structured body of the heating system.

FIG. 3 is a flow-chart of some of the steps of a possible method of manufacturing a macroscopic structure for use in a heating system.

FIG. 4 shows schematically a processing step of a possible method of manufacturing a macroscopic structure for use in a heating system.

FIG. 5 shows schematically a macroscopic structure having a varying electric resistivity in a direction extending from the inlet port to the outlet port.

FIG. 6 shows schematically a method of manufacturing the macroscopic structure in FIG. 5.

FIGS. 7 to 10 show schematically cross-sectional views of different embodiments of a heating system according to the present invention.

FIG. 11 shows schematically how a system according to the present invention provides for a more uniform temperature distribution than a known system.

### DETAILED DESCRIPTION OF AN EMBODIMENT

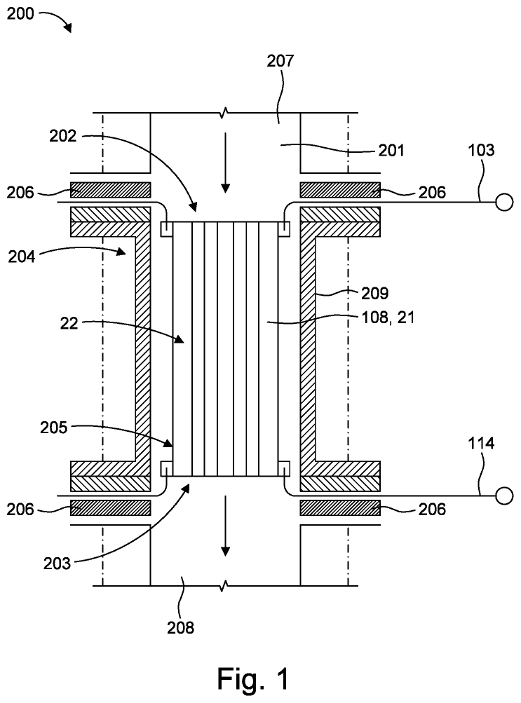

FIG. 1 shows schematically an embodiment of a heating system 200 for heating of a fluid. The heating system 200 comprises a supply connection 201 in fluid communication with a supply of fluid to be heated (not shown). The supply of fluid can be a part of the heating system 200 or an external supply. A structured body 108 is arranged for heating of the fluid during use of the heating system 200. The structured body 108 comprises a macroscopic structure 21 of electrically conductive material. In some embodiments of the invention, the macroscopic structure 21 forms all of the structured body 108. The macroscopic structure 21 comprises at least one channel 22 through which the fluid can flow. In the illustrated embodiment, there are a plurality of parallel channels 22. The heating system 200 comprises an inlet port 202 through which the fluid to be heated can flow from the supply connection 201 and into the channels 22 and an outlet port 203 through which heated fluid can flow out of the channels 22. Conductors 103, 114 electrically connect the structured body 108 to an electrical power supply (not shown).

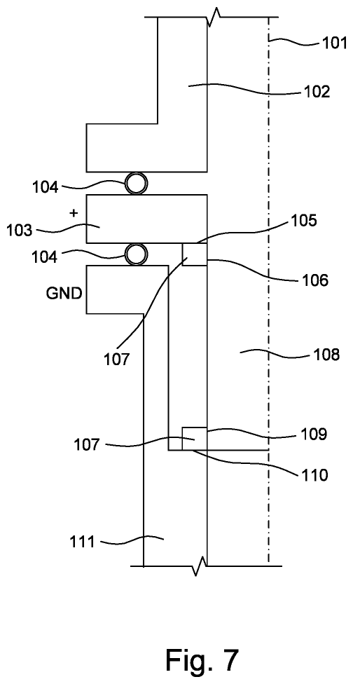

The conductors 103, 114 are electrically connected to the structured body 108 at a first end 204 and at a second end 205, respectively, of a conductive path within the structured body 108. In the illustrated embodiment, the conductive path runs from an upper end of the structured body 108 to a lower end of the structured body 108. In other embodiments, the conductive path runs in different ways as will be exemplified in FIGS. 7 to 10. The structured body 108 is configured to direct an electrical current to run along the conductive path from the first end 204 to the second end 205 thereof. The electrical power supply is used to heat at least part of said structured body 108 to a temperature of below 400° C. by passing an electrical current through said structured body 108 during use of the heating system 200. In the embodiment illustrated in FIG. 1, the heating system 200 is provided with gaskets 206 at the inlet port 202 and at the outlet port 203 to ensure a fluid tight connection to a pipe 207 through which the fluid to be heated flows into the system and to a pipe 208 through which the heated fluid flows out of and away from the heating system 200. The resistance of the structured body is a function of the electric resistivity, the cross sectional area perpendicular to the current, and the length of the current path, and it can be determined using Ohm's law. In more advanced cases, finite element analysis can be used to calculate the current given the electrical potential (voltage) or vice versa. Having both the current and voltage, the resistance is voltage divided by current. These parameters can be used in the design of the heating system for a given application; i.e. for a given fluid, flow rate etc. Having the resistance, a suitable power supply can be found. The power from the supply is voltage times current. The necessary power for heating the fluid is calculated using thermodynamics.

The heating system 200 as shown in FIG. 1 comprises an outer housing 209 enclosing the structured body 108 and forming a fluid tight enclosure extending from the inlet port 202 to the outlet port 203. In alternative embodiments (not shown), the structured body 108 has a design so that it in itself comprises an outer circumferential wall which provides a fluid tight barrier towards the exterior, the fluid tight barrier extending from the inlet port to the outlet port. The outer housing 209 as shown in FIG. 1 may also be provided with a surrounding outer electrically insulating covering and/or thermally insulating covering. Such a covering could e.g. be an integrated part of the outer housing 209.

As mentioned above, a heating system 200 according to the present invention may e.g. be used for heating of portable water, disinfection of water, evaporation of liquids i.e. making steam, and heating of steam.

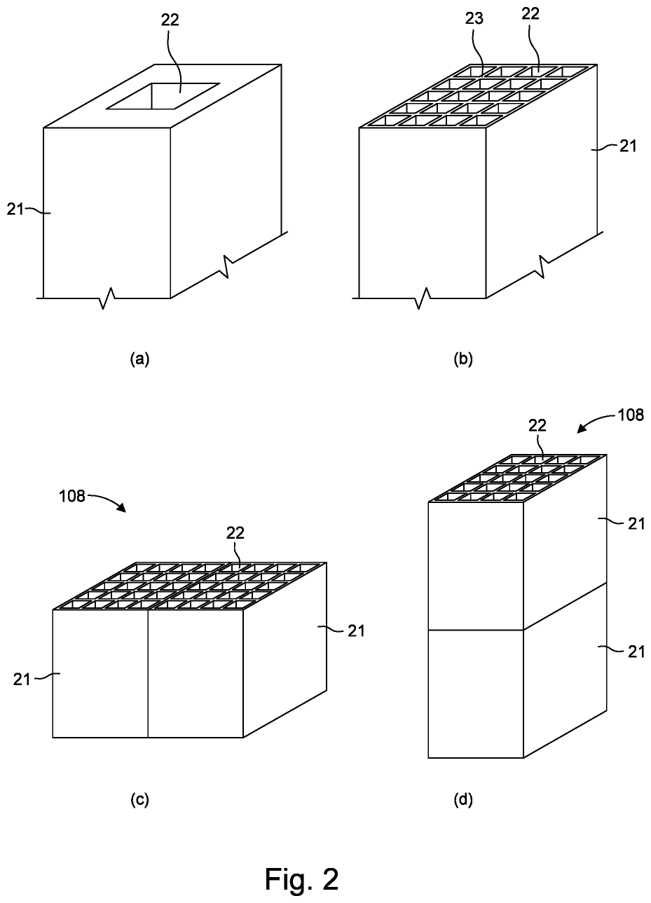

The macroscopic structure 21 may be a sintered powder metallurgical structure. FIG. 2 shows schematically examples of possible designs of the structured body of the heating system. In FIGS. 2.a and 2.b, the structured body comprises one macroscopic structure 21, and in FIGS. 2.c and 2.d, the structured body 108 comprises two macroscopic structures 21 which have been joined in a manner which ensures that they form a coherent conductive path. FIG. 2.a shows a macroscopic structure 21 having one longitudinally extending channel 22, and FIG. 2.b shows a macroscopic structure 21 having a plurality of longitudinally extending internal channels 22 which are arranged in a regular pattern separated by walls 23. FIG. 2.c shows an embodiment wherein two macroscopic structures 21 in the form of block-shaped elements comprising longitudinally extending channels 22 are arranged next to each other side by side so that the structured body 108 has a number of channels 22 which is a sum of a number of channels 22 in the first macroscopic structure 21 and a number of channels 22 in the second macroscopic structure 21. FIG. 2.d shows another embodiment wherein the two macroscopic structures 21 are arranged so that the channels 22 of the macroscopic structures 21 are in continuation of each other. The macroscopic structures 21 in FIGS. 2.c and 2.d may have been joined by sintering in a manner that ensures a coherent electrically conductive structure.

Experiments performed during the development work leading to the present invention have shown that it is possible to manufacture macroscopic structures 21, wherein walls 23 forming the longitudinally extending internal channels 22 have a wall thickness of between 0.25 and 2 mm, such as between 0.25 and 1 mm, such as between 0.25 and 0.5 mm. In the embodiments shown in FIG. 2, the cross-sectional shape of the channels is quadratic, but any shape that is possible to manufacture, e.g. by extrusion, is covered by the scope of the present invention. The cross-sections of the channels may e.g. be circular or hexagonal. The outer geometry of the macroscopic structure may also differ from the ones shown in this and the following figures. It may e.g. be circular, hexagonal, or rectangular.

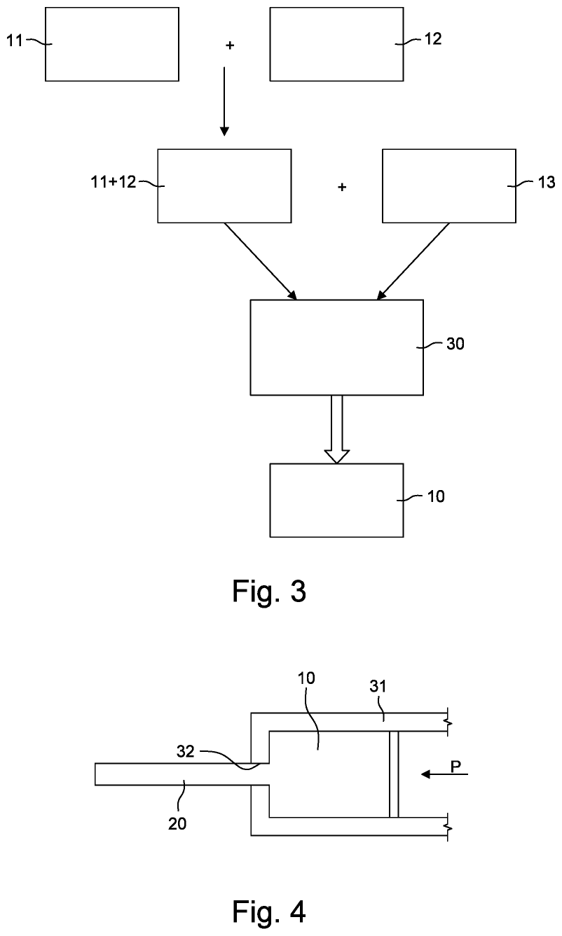

The macroscopic structure 21 can be manufactured by a method having the first steps that are shown as a flow-chart in FIG. 3. A paste 10 is prepared by first mixing a powder 11 and a binder 12 in an amount of 2 to 8 weight % of the paste 10. The powder 11 comprises metal and may also comprise ceramic. The liquid is in the following described as being water 13, but other liquids may also be used as mentioned above. It is added in an amount of 5 to 25 weight % of the paste 10. In the illustrated embodiment, the adding of water 13 and kneading to obtain a homogenous paste is performed in a kneader 30, such as a Z-blade kneader or sigma blade kneader. The prepared paste 10 is then transferred to an extruder 31, where it is extruded into a green body 20 as shown schematically in FIG. 4. This step is preferably performed by using an extrusion pressure P of more than 50 bar. In some embodiments of the invention, the extrusion pressure P is between 50 and 500 bar, such as between 50 and 200 bar, preferably between 60 and 160 bar. The green body 20 is then dried and sintered in order to obtain the final macroscopic structure to establish the macroscopic structure of a heating system, such as the one in FIG. 1.

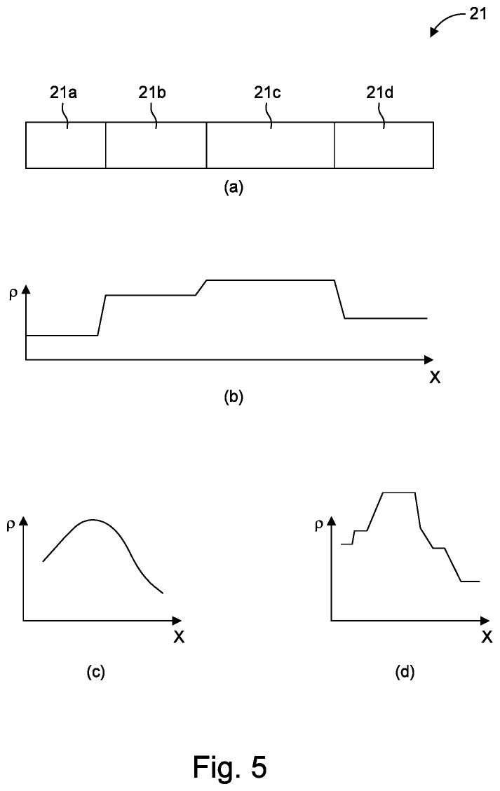

The macroscopic structure 21 may have a varying electric resistivity in a direction extending from the inlet port 202 to the outlet port 203; see FIG. 1. FIG. 5.a shows schematically an example of such a macroscopic structure 21 which has four regions 21a, 21b, 21c, 21d with different resistivities along the longitudinal direction of the macroscopic structure 21. FIG. 5.b shows a curve of the electric resistivity p as a function of position along the length X of the macroscopic structure 21 in FIG. 5.a. In this illustrated embodiment, the electric resistivity varies in steps and with a constant increase rate in the narrow regions around the borders between the different regions 21a, 21b, 21c, 21d. FIG. 5.c shows schematically an example of what could be an ideal curve for a given application of the heating system where a smooth change in electric resistivity p would be desired. FIG. 5.d shows an example of an actual curve for a macroscopic structure to be used in the application having the ideal curve as in FIG. 5.c.

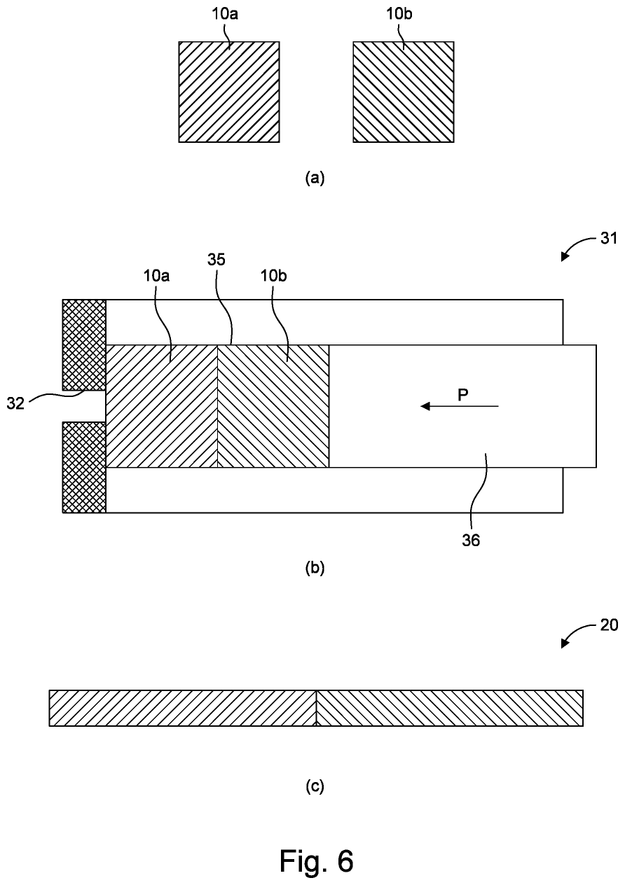

The macroscopic structure 21 in FIG. 5 can be prepared as shown schematically in FIG. 6. FIG. 6.a shows the step of preparing a first paste 10a having a first composition, and a second paste 10b having a second composition. The first and second pastes 10a, 10b are then transferred into a supply chamber 35 of a processing equipment 31, which in FIG. 6.b is schematically shown as a piston extruder. The pastes 10a, 10b are forced from the supply chamber 35 through a die 32 of the processing equipment 31 to result in a green specimen 20 as shown in FIG. 6.c. By moving the piston 36 towards the die 32 at a constant speed, the green body 20 is formed by continuously forcing the pastes 10a, 10b through the die 32. As shown for this embodiment, the order in which the pastes 10a, 10b are transferred into the supply chamber 35 corresponds to the longitudinal direction of the macroscopic structure 21 being manufactured. After this shaping, and possibly a further step of drying, the green body is sintered to obtain the macroscopic structure 21 having a varying electric resistivity along a longitudinal direction thereof. As seen from FIG. 6, the longitudinal direction of the macroscopic structure 21 corresponds to the direction of movement of the pastes 10a, 10b through the die 32, and the varying electric resistivity p results from the first composition being different from the second composition.

In preferred embodiments of the invention, the first paste 10a comprises metal powder with a first alloy composition, ceramic powder, and a first binder. The second paste 10b comprises metal powder with a second alloy composition and a second binder. The first alloy composition and the second alloy composition both consist of a plurality of chemical elements. Each of the metal powders of the first paste 10a and of the second paste 10b may comprise one or more of the following chemical elements: iron, chromium, aluminium, cobalt, nickel, manganese, molybdenum, vanadium, and silicon. Examples of alloys that have been used in the development work leading to the present invention are FeCrAl, TWIP, 316L, and 17-4PH. However, the invention can be used for many other alloys.

The second paste 10b typically also comprises a ceramic powder. The ceramic powder used for the first and second compositions typically comprises one or more of the following: Alumina, Zirconia, Boron Nitride, Cordierite, and Silicon Nitride. In embodiments comprising ceramic powder, the different resistivities p in the pastes 10a, 10b are typically obtained by varying one or more of the following parameters:
the volume ratio between the metal powder and the ceramic powder,
the size of the ceramic particles,
the shape of the ceramic particles, and
the type of the ceramic material.

FIG. 7 shows schematically a cross-sectional partial view of an embodiment of a heating system 200 according to the present invention. In this and the following embodiments, the heating system 200 is symmetrical, and the axis of symmetry is marked as number 101. The description will be given with reference to structured bodies 108 having a circular cross-section. However, similar details as shown in these figures could also be used for non-symmetrical designs of the heating system. The structured bodies 108 in FIGS. 7 to 10 are shown as one unit which could be either one macroscopic structure 21 or be assembled from a plurality of macroscopic structures 21, such as e.g. shown in FIG. 2.c. The heating system 200 in FIG. 7 is illustrated as having a first conductor 103 connected to the structured body 108 at an upper end (with respect to the figure) via an electrically conducting ring 107 that extends circumferentially around the structured body 108. The first conductor 103 is marked as being connected to the positive pole (marked as +) of the power supply. Furthermore, the heating system 200 has a second conductor 111 connected to the structured body 108 at a lower end (with respect to the figure) also via an electrically conducting ring 107 that extends circumferentially around the structured body 108. The second conductor 111 is connected to ground, marked as GND. In this embodiment, the second conductor 111 also forms a bottom flange used for the mounting of the heating system 200, e.g. to a carrying frame. The heating system 200 may comprise more connectors than the ones shown in the figures, such as connectors arranged symmetrically to the illustrated ones. The electrical connections between the conductors 103, 111 and the conducting rings 107 as well as between the conducting rings 107 and the structured body 108 may be established by any joining method that ensures an electrically conducting joint, such as by laser welding, arc welding, soldering, brazing, or sintering. A better connection may be established by additionally applying a pressure. The heating system 200 in FIG. 7 further comprises a top flange 102, which may be used for mounting of the heating system 200. The fluid may be led to and from the heating system 200 directly via the top and bottom flanges 102, 111 being in the form of tubes. Alternatively, the heating system 200 comprises additional tubes through which the fluid flows and to which the heating system is connected. In the embodiment in FIG. 7, O-rings 104 are arranged above and below the first conductor 103 to provide electric insulation as well as sealing. The O-rings 104 are arranged in engagement with horizontally extending parts of the top flange 102 and of the bottom flange 111. The heating systems shown in FIGS. 7 to 10 also comprise contact points marked as 105, 109, and 110. They could e.g. be established by welding, soldering, brazing, thermal spraying, or sintering. For some designs of the system, it may also be sufficient to obtain the necessary contact by ensuring that a mechanical pressure is applied and maintained during use of the system. Such a pressure might e.g. be obtained by the bolts and nuts used for the assembly of the components.

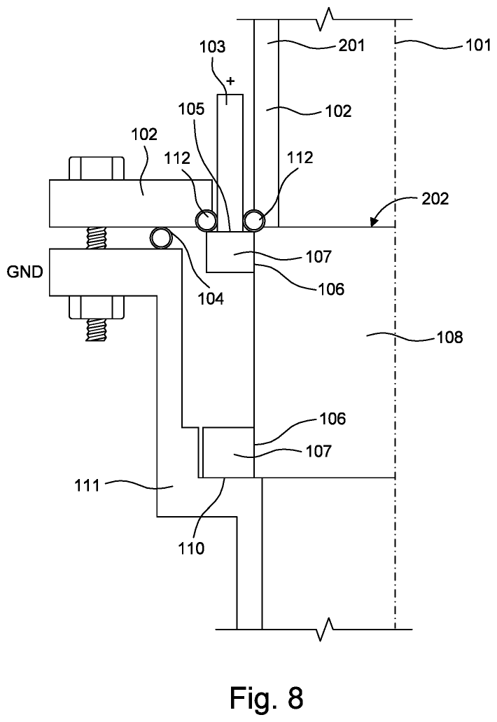

FIG. 8 shows schematically a cross-sectional partial view of another embodiment of a heating system 200 according to the present invention. Similar numbers are used in FIG. 8 for similar components as in FIG. 7; the description thereof will not be repeated. In FIG. 8, the first conductor 103 extends upwards between two parts of the top flange 102. The horizontally extending part of the top flange 102 is connected to the bottom flange 111 by use of a bolt-and-nut connection. In this embodiment, O-rings 104, 112 are arranged on both sides of the first conductor 103 as well as between the top flange 102 and the bottom flange 111. The upwardly extending part of the top flange 102 may be a pipe forming the supply connection 201 through which the fluid is led from the fluid supply an into the heating system 200 via the inlet port 202.

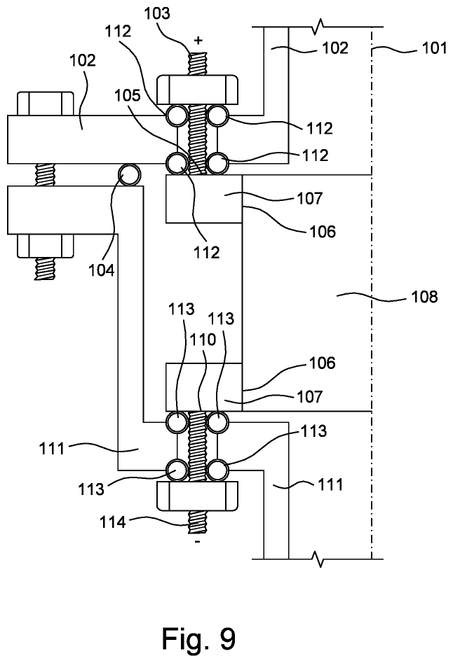

FIG. 9 shows schematically a cross-sectional partial view of another embodiment of a heating system 200 according to the present invention. In this embodiment, a second conductor 114 (marked with —) forms the electrical connection to the negative pole of the power supply. The conductors 103, 114 are electrically connected to the structured body 108 as described above. The two conductors 103, 114 of this embodiment are provided with outer threading engaged with nuts so that they are used for the mounting of the heating system 200 as shown in the figure. O-rings 112, 113 are arranged around the conductors 103, 114 to form the electrical insulation and sealing thereof.

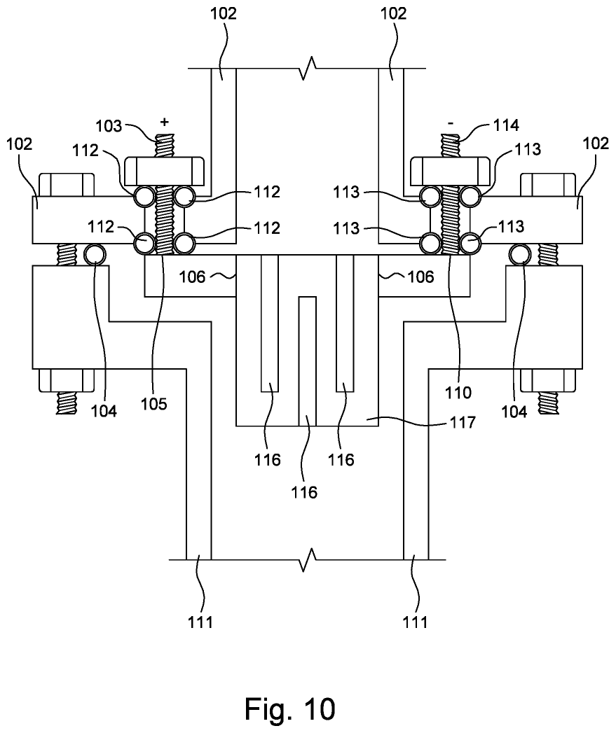

FIG. 10 shows schematically a cross-sectional view of another embodiment of a heating system 200 according to the present invention. In this embodiment, the conductors 103, 114 establishing the connections to the positive and negative poles of the power supply are arranged at opposite sides of the heating system 200 and both extend upwards. The structured body 117 comprises electrically insulating regions 116 so that the conductive path runs in a meandering manner between the first end and second end 106 of the conductive path. The electrically insulating regions 116 may e.g. be formed by ceramic material, polymer material, or air gaps. Such a structured body 117 may e.g. be established by cutting slots in one macroscopic body 21, or it may be established by assembly of a plurality of macroscopic bodies 21. By a design of the heating system as exemplified in FIG. 10, the conductors 103, 114 can be arranged at the end of the structured body where the fluid to be heated flows into the at least one channel via an inlet port, i.e. the end where the fluid has not yet been heated by the heating system. By designing the structured body 117 so that the conductive path runs in a meandering manner between the first and second ends of the conductive path, a better utilization of the heating capacity of the whole volume of the macroscopic structure is obtained, because of the use of a larger surface area to establish the interface between the macroscopic structure and the fluid to be heated.

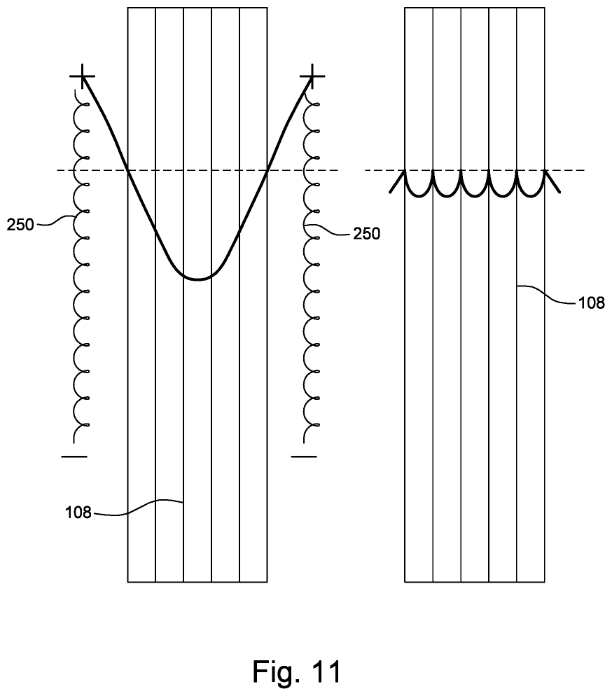

FIG. 11 illustrates schematically one of the advantages of a heating system according to the present invention, namely that the temperature is more homogeneous over the whole cross-section of the heat providing element than what would be the case for a system based on an external heating source arranged next to the heat providing element. The left system in FIG. 11 is a known system with an external heating source schematically illustrated as electrical coils 250. The heat providing element is the structured body 108 through which the fluid to be heated flows. The bold curve illustrates a typical temperature curve for such a system; i.e. a lower temperature in the central region of the structured body 108 than near the edges. The left system is a system according to the present invention, wherein the heating is provided via the structured body 108, i.e. across the whole cross-section. This results in a temperature curve, shown as the bold line, which is much closer to a desired temperature, shown as a dotted line.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Furthermore, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A heating system for heating of a fluid, said heating system comprising:
a supply connection in fluid communication with a supply of fluid to be heated;
a structured body arranged for heating of said fluid during use of the heating system, said structured body comprising a macroscopic structure of electrically conductive material, the macroscopic structure comprising at least one channel through which the fluid can flow,
at least one inlet port through which the fluid to be heated can flow from the supply connection and into the at least one channel,
at least one outlet port through which heated fluid can flow out of the at least one channel, and
at least two conductors configured to electrically connect the structured body to at least one electrical power supply,
wherein the at least two conductors are electrically connected to the structured body at a first end and at a second end, respectively, of an electrically conductive path within the structured body,
wherein the structured body is configured to direct an electrical current to run along the conductive path from the first end to the second end thereof, and
wherein said electrical power supply is configured to be used to heat at least part of said structured body to a temperature of below 400° C. by passing an electrical current through said structured body during use of the heating system.

2. Heating system according to claim 1, wherein the macroscopic structure is a sintered or oxidized powder metallurgical structure.

3. Heating system according to claim 2, wherein the macroscopic structure is manufactured by a method comprising the following steps:
preparing a paste by mixing at least:
a powder comprising metal,
a binder in an amount of 2 to 8 weight % of the paste,
liquid, such as water, in an amount of 5 to 25 weight % of the paste,
transferring the paste to an extruder,
extruding the paste into a green body by using an extrusion pressure (P) of more than 50 bar,
drying the green body, and
sintering or oxidizing the dried green body to bond the powder together and thereby form the macroscopic structure.

4. Heating system according to claim 1, wherein the macroscopic structure has a varying electric resistivity in a direction extending from the inlet port to the outlet port.

5. Heating system according to claim 1, wherein the macroscopic structure has a varying electric resistivity transverse to a direction extending from the inlet port to the outlet port.

6. Heating system according to claim 4, wherein the varying electric resistivity has been obtained by a method of manufacturing comprising the following steps:
preparing a plurality of pastes comprising:
at least a first paste having a first composition, and
at least a second paste having a second composition,
transferring the plurality of pastes into a supply chamber of a processing equipment,
shaping a green body from the plurality of pastes by forcing the pastes from the supply chamber through a die of the processing equipment, and
sintering or oxidizing the green body to obtain the macroscopic structure having a varying electric resistivity along a longitudinal direction of the macroscopic structure, the longitudinal direction corresponding to the direction of movement of the pastes through the die, and the varying electric resistivity resulting from the first composition being different from the second composition.

7. Heating system according to claim 6, wherein:
the first paste comprises metal powder with a first alloy composition, ceramic powder, and a first binder,
the second paste comprises metal powder with a second alloy composition and a second binder, and
wherein the first alloy composition and the second alloy composition both consist of at least one chemical element, and wherein the chemical elements are chosen so that, for each of the chemical elements being present in an amount higher than 0.5 weight % in each of the alloy compositions, that chemical element is comprised both in the first and second alloy composition, and
for the chemical elements being present in the first alloy composition in amounts of up to 5.0 weight %, the amount of that chemical element differs by at most 1 percentage point between the first and second alloy compositions, and
for the chemical elements being present in the first alloy composition in amounts of more than 5.0 weight %, the amount of that chemical element differs by at most 3 percentage point between the first and second alloy compositions.

8. Heating system according to claim 1, wherein the macroscopic structure comprises a plurality of longitudinally extending channels.

9. Heating system according to claim 1, wherein the macroscopic structure is made from a non-corrosive material or is provided with a coating, such as a coating of non-corrosive material, at least on surfaces being in contact with the fluid during use of the heating system.

10. Heating system according to claim 1, wherein the connections between the at least two conductors and the structured body are established by sintering.

11. Heating system according to claim 1, wherein the structured body is built-up of two or more macroscopic structures which have been mutually joined by an electrically conducting connection.

12. Heating system according to claim 11, wherein the macroscopic structure is a sintered or oxidized powder metallurgical structure wherein the macroscopic structures have been joined by sintering.

13. Heating system according to claim 1, wherein the first end and the second end of the electrically conductive path to which the at least two conductors are electrically connected are located at an end of the structured body comprising the inlet port.

14. Heating system according to claim 13, wherein:
the conductors are arranged at opposite sides of the heating system and both extend in the same direction parallel to a longitudinal direction of the structured body, and
the structured body comprises electrically insulating regions so that the conductive path runs in a meandering manner between the first end and the second end of the conductive path.

15. Heating system according to claim 1, further comprising an outer housing enclosing at least a part of the structured body and forming a fluid tight enclosure extending from the inlet port to the outlet port.

16. Method of heating a fluid to a temperature of below 400° C. by use of a heating system according to claim 1.

17. Method according to claim 16, wherein the fluid is a liquid, such as water, which is heated to a temperature of below 100° C., such as between 50 and 100° C., such as between 70 and 100° C.

18. Method according to claim 16, wherein the fluid, such as being a gas, is heated to a temperature of between 200 and 400° C., such as between 300 and 400° C.

19. Method according to claim 16, further comprising a step of transferring the heated fluid from the at least one outlet port to a storage for storing the heated fluid as an energy reservoir.

20. Heating system according to claim 3, wherein the macroscopic structure is a sintered or oxidized powder metallurgical structure, and wherein the macroscopic structure has a varying electric resistivity in a direction extending from the inlet port to the outlet port.
